(19) United States
(12) Patent Application Publication
(10) Pub. No.: US 2002/0144884 A1
(43) Pub. Date: Oct. 10, 2002

(54) Key Switch

(75) Inventor: Akio Kurihara, Tokyo (JP)

Correspondence Address: FOLEY AND LARDNER, SUITE 500, 3000 K STREET NW, WASHINGTON, DC, 20007, US

(73) Assignee: NEC CORPORATION

(21) Appl. No.: 10/105,224

(22) Filed: Mar. 26, 2002

(30) Foreign Application Priority Data
Mar. 26, 2001 (JP) 2001-087033

(51) Int. Cl. H01H 1/04

(52) U.S. Cl. 200/263

(57) ABSTRACT

A button base 4 with a button depressing surface 4b and a shaft portion 4c, and a shaft supporting portion 2c for slidably supporting the shaft portion 4c of the button base 4 are provided. A switch base 2 installable on a print wiring board 19, a contact rubber 3 providing a conductive portion 13 at a position facing to the print wiring board 19, and a light emitting portion 15 provided on the printing wiring board 19 are included. The shaft portion 4c is lowered by depressing the button depressing surface 4b of the button base 4 and the conductive portion 13 of the contact rubber 3 is lowered until the conductive portion 13 contacts an electrical contact 14 on the print wiring board 19. Thus, an electrical contact function is exerted and the light emitting portion 15 emits light, when the conduct portion 13 comes into contact with the electrical contact.

### BACKGROUND OF THE INVENTION

The present invention relates to a key switch, and more particularly to a push-button key switch used in a communications unit, a keyboard for data inputting, an operating panel and the like.

Conventionally, a key switch whose light emitting portion of an integrated LED and the like illuminates on pressure of the push button switch is variously used in a communications unit, a keyboard for data inputting, an operating panel and the like.

For example, an illuminated push button described in unexamined Japanese Patent Publication No. Hei 11-73838 installs an LED and provides a print board on which a wiring pattern is formed integrated in a base for providing an illuminated push button capable of leading light emitted from a luminous element to a display portion without passing the light through a member manufactured of a sealant. On the print board,

a silicon cover functioning as a sealant in which a reflect case is integrated and as a movable contact

a reflect case mounted in the silicon cover,

a filter fitting with the reflect case and the silicon cover internally, and

a lens for covering the above-mentioned elements are disposed sequentially in a vertical direction. The above-mentioned elements are housed in a covering member fixed on the base. Further, the silicon cover has apertures on both upper and lower surfaces, and a conductive portion which contacts the wiring pattern on operation is provided on a lower surface of a corner portion.

On the other hand, in Utility Model Publication No. Hei 4-127929, an installing construction of a luminous element in a membrane-contact-type keyboard in which a circuit pattern for a luminous element is formed in a spacer of a membrane sheet as well and parts except for an installing portion for the luminous element is subjected to insulation processing is disclosed in order to provide the installing construction of a luminous element in a membrane-contact-type keyboard without requiring complicated run of a pattern and additional print wiring boards even in the event the number of the luminous element becomes larger.

However, the above-mentioned illuminated push button described in unexamined Japanese Patent Publication No. Hei 11-73838 is composed as to perform external switch connecting information (an electrical contact) via a connector installed in each button and the connector is required to be installed and soldered on the reverse side of an installed LED, which causes problems of cumbersome assembly tasks and less productivity.

Additionally, in fixing the push button, protrusions provided on the base member is composed as to mate to holes drilled in a board for fixing a plurality of push buttons, and in the event of installing a plurality of push buttons, a required number of holes must be drilled in the board for fixing the push button. And in the event of changing positions of the a push button, boards for fixing the push button must be prepared for each disposition of the push button, which causes a problem of having low flexibility in disposing the push button on the print wiring board.

Further, a problem also arises that a high parts count results in high manufacturing costs, because eight parts are required except for the LED installed in the print wiring board.

On the other hand, in the technology described in Utility Model Publication No. Hei 4-127929 causes problems of cumbersome assembly tasks and less productivity, because the LED must be soldered after installing an LED holder on a substrate disposed on a membrane adjacent surface per each switch unit and the a housing is composed to cover the LED and fixed by brackets.

Further, the LED provided in the membrane-contact-type switch is soldered on the substrate and a window for checking light being turned on or off is provided at upper part of the LED in a key top. While the key top is not depressed, a light emitting surface of the LED is in a state of being buried in the key top, which causes a problem of providing a poor visual recognition from other directions than upper part of the key top.

Furthermore, a problem arises that a high parts count results in high manufacturing costs, because six parts are required except for the LED installed in the print wiring board.

### SUMMARY OF THE INVENTION

In the view of the foregoing problems and disadvantages of the conventional technology, it is therefore an object of the present invention to provide a key switch capable of providing outstanding productivity because of easy assembly tasks and a low parts count, high degree of flexibility in disposing the key switch on a print wiring board and advantages in visual recognition from other direction than upper part of the key top.

In addition to the above-mentioned advantages, it is another object of the present invention to provide a key switch which can be fixed securely on a print wiring board without misregistration when installed in and requirement of no other part for fixing and can fix adjacent key switches securely in the event of successive installation of the key switches.

Further, it is still another object of the present invention to provide a key switch for enhancing keying life with high reliability.

To achieve the above-mentioned objects, the invention claimed in claim 1 is a key switch comprising;

a button base providing a button depressing surface and a shaft portion successively provided to the button depressing surface, and

a shaft supporting portion for slidably supporting the above-mentioned shaft portion of the button base, having;

a switch base moutable on a print wiring board,

a contact rubber mounted on the above-mentioned print wiring board accessibly to an end of a reverse side of the above-mentioned button depressing surface of the shaft portion in the above-mentioned button base, providing a conductive portion in a position facing to the above-mentioned print wiring board, and

a light emitting portion provided on the above-mentioned print wiring board, is characterized in that;

the above-mentioned shaft portion is lowered by depressing the above-mentioned button depressing surface of the above-mentioned button base, the above-mentioned conductive portion of the above-mentioned contact rubber is lowered subsequently to the descent of the above-mentioned shaft portion,

electrical contact function is exerted by contact of the above-mentioned conductive portion with an electrical contact on the above-mentioned print wiling board, and

the above-mentioned light emitting portion emits light when the above-mentioned conductive portion makes contact with the above-mentioned electrical contact.

According to the invention claimed in claim 1, assembly of key switch can be performed easily and workability can be improved, because conventional installation, soldering and the like of a connector is not required in each key switch unit. And only four parts are required except for an LED installed in the print wiring board, which realizes lowered parts count and manufacturing costs.

Further, the invention claimed in claim 2 is characterized in that the above-mentioned switch base is detachable from the above-mentioned print wiring board in the key switch as claimed in claim 1.

According to the key switch claimed in claim 2, being detachable from the print wiring board, higher flexibility in disposing the key switch on the print wiring board is provided and dispositions can be changed easily. Further, a conventional structure for supporting the key switch is not required and costs for developing an operating panel surface to which the present key switch is applied can be cut down.

The invention claimed in claim 3 is characterized in that the key switch is mountable in the print wiring board by inserting and locking a lug portion protruding from a lower portion of the switch base to a through hole drilled in the print wiring board, as a preferred aspect of the key switch as claimed in claim 2. Thus, the key switch can be detachable from the print wiring board with a simple composition.

The invention claimed in claim 4 is characterized in that the key switch can be registered with respect to the above-mentioned print wiring board by protruding a guide pin at lower portion of the above-mentioned switch base and inserting the guide pin into a fixing hole drilled in the above-mentioned print wiring board in the key switch as claimed in at least one of claims 1, 2 or 3.

According to the invention claimed in claim 4, registration of the key switch with respect to the print wiring board can be performed by the guide pin of the switch base, which results in avoiding misregistration when installed in the print wiring board.

The invention claimed in claim 5 is characterized in that each of the above-mentioned switch bases of the above-mentioned adjacent key switches is engagable to an adjacent switch base in the key switch claimed in at least one of claims 1 through 4.

According to the invention claimed in claim 5, switches can be combined firmly to each other even in the event of installing the key switches successively. And no other part is required for the combination.

The invention claimed in claim 6 is characterized in that the above-mentioned adjacent key switches are engagable to each other by fitting a convex portion protruded from the above-mentioned switch base on one side to a concave portion formed in the above-mentioned switch base on the other side of the above-mentioned key switch, as a preferred aspect of the key switch claimed in claim 5. Thus, the key switches adjacent to each other can be combined firmly with a simple composition.

The invention claimed in claim 7 is characterized in that a sliding range of the shaft portion of the above-mentioned button base along the shaft supporting portion of the above-mentioned switch base is set not shorter than a fixed length in the key switch claimed in at least one of claims 1 through 6. For example, by providing the sliding range is set at not shorter than eight millimeters, slant of the button base and scoring on a sliding surface during sliding can be suppressed and keying life of a thousand times can be ensured.

The invention claimed in claim 8 is characterized in that a lens for leading light emitted from the light emitting diode (LED) installed in the above-mentioned print wiring board as a light emitting portion for emitting light when the above-mentioned conductive portion contacts the above-mentioned electrical contact to outside through notches formed on the button depressing surface of the above-mentioned button base is provided in the key switch as claimed in at least one of claims 1 through 7.

According to the invention claimed in claim 8, for example, an LED illuminated key switch can be disposed successively with 19-millimeter pitch, because the key switch can singly satisfy an emission of light emitting diode (LED) and a function of electrical contact.

The invention claimed in claim 9 characterized in providing a label removably on the button depressing surface of the above-mentioned button base, as a preferred aspect of the key switch as claimed in at least one of claims 1 through 8.

The invention claimed in claim 10 is characterized in providing a key cap for surrounding the button depressing surface of the button base mountably on the above-mentioned button base, as a preferred aspect of the key switch as claimed in at least one of claims 1 through 9.

### BRIEF DESCRIPTION OF THE DRAWINGS

FIG. 1 is a sectional view for illustrating a first embodiment of a key switch relating to the present invention,

FIG. 2 is a partially interrupted perspective view for showing the key switch of FIG. 1,

FIG. 3 is a sectional view for showing the key switch of FIG. 1 illustrating a state in which a lug of the key switch is inserted into a print wiring board,

FIG. 4 is a partially interrupted perspective view for showing the key switch of FIG. 3,

FIG. 5 is an exploded perspective view for showing the key switch of FIG. 1

FIG. 6 is an assembling perspective view for showing the key switch of FIG. 5,

FIG. 7 is a three-view diagram for showing the switch base of the key switch of FIG. 1 and (a), (b) and (c) are a front view, a side view and a top view thereof respectively,

FIG. 8 is a top view for illustrating the key switches of FIG. 1 in the state of being installed successively,

FIG. 9 is a perspective view for illustrating four of the key switches of FIG. 1 in the state of being installed successively on print wiring boards,

FIG. 10 is a perspective view for illustrating a second embodiment of the key switch relating to the present invention, and

FIG. 11 is a perspective view for illustrating a third embodiment of the key switch relating to the present invention.

### DETAILED DESCRIPTION OF THE PREFERRED EMBODIMENTS

Referring now to the drawings, concrete examples of preferred embodiments of a key switch relating to the present invention are described as follows.

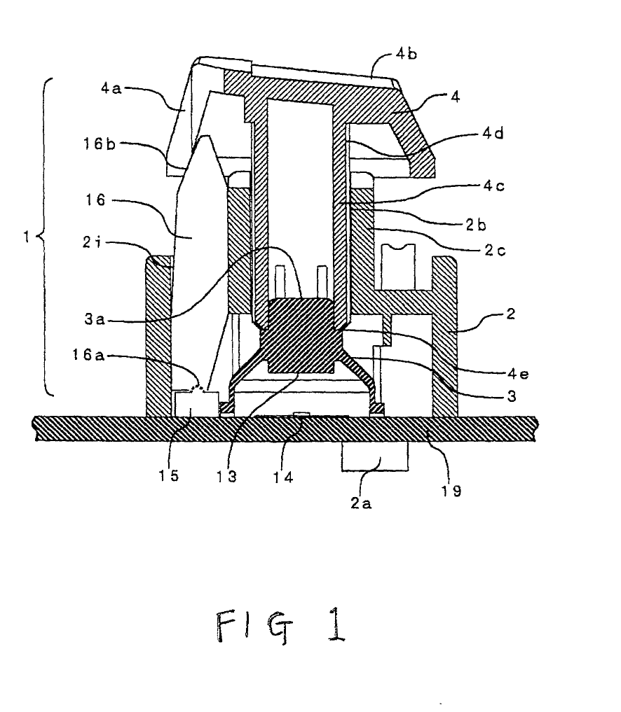

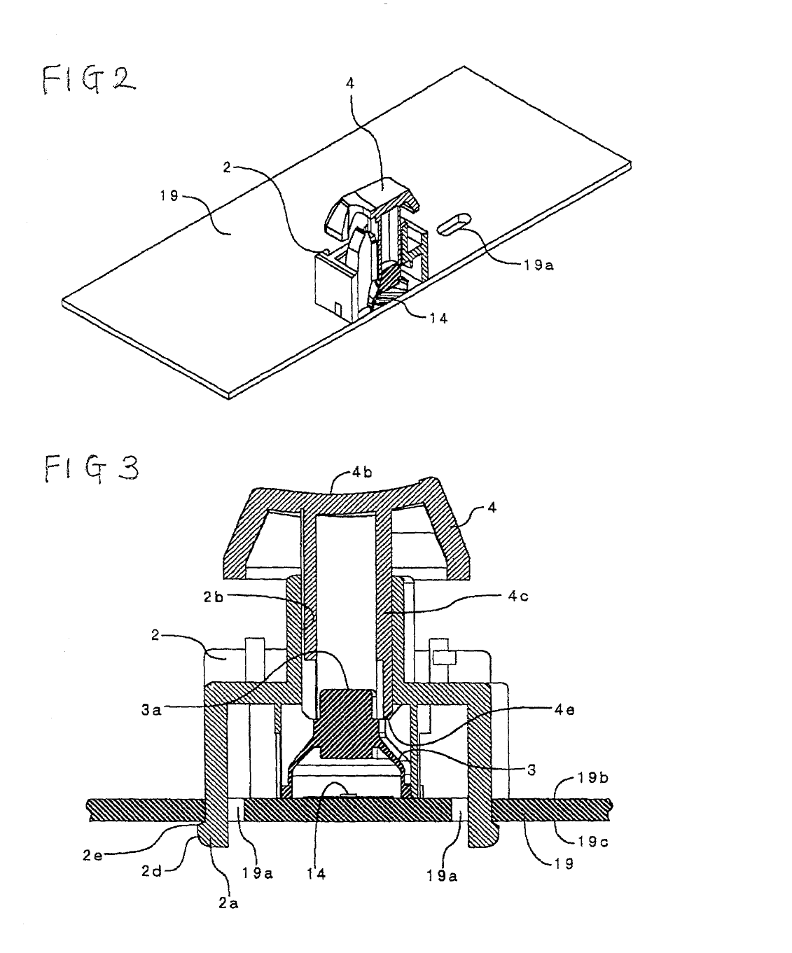

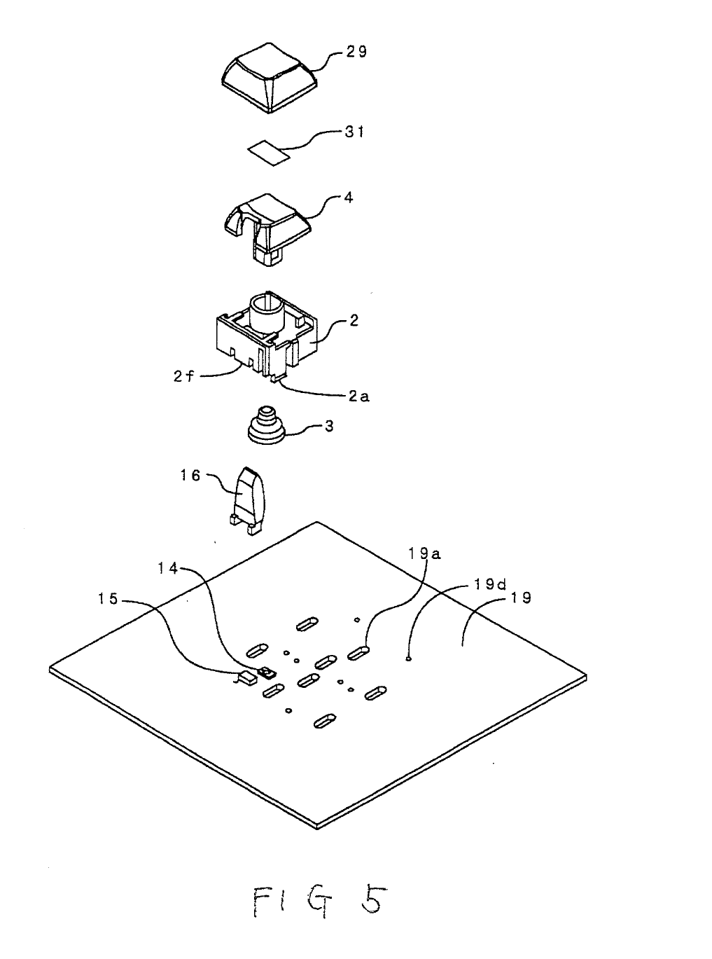

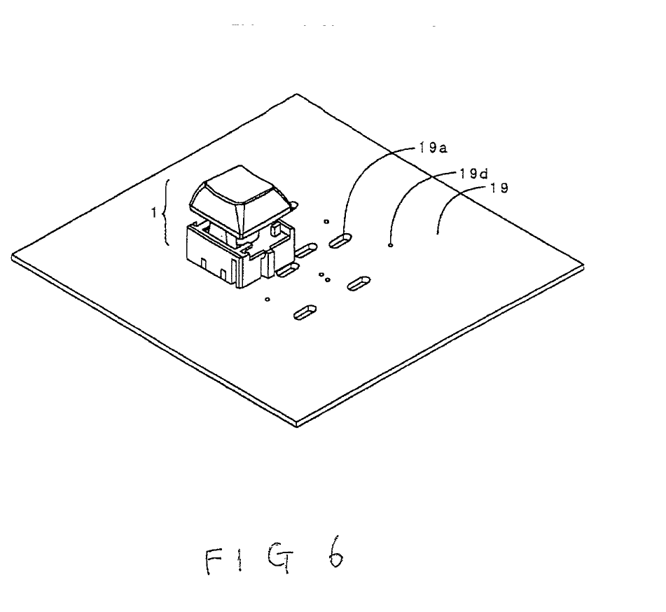

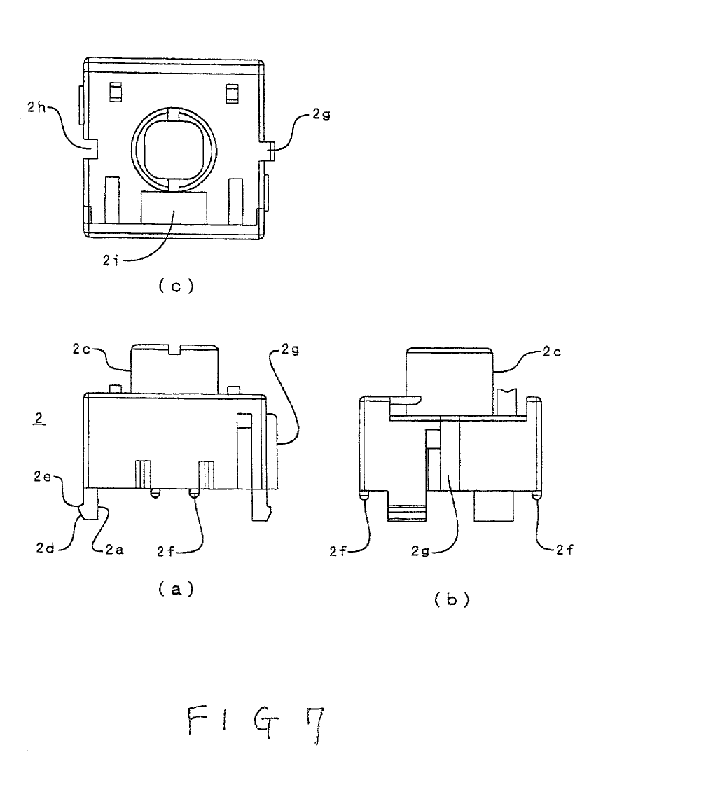

FIGS. 1 through 7 illustrate the key switch relating to the present invention, which broadly comprising a switch base 2, a button base 4, a contact rubber 3, a light conductive lens 16, a key cap 29 (FIG. 5) and a label 31.

As shown in FIGS. 1, 3 and 7, the switch base 2 comprises a shaft supporting portion 2c with a sliding surface 2b, a lug 2a with a lug taper portion 2d and a protruding surface 2e, a guide pin 2f, a switch base convex portion 2g, a switch base concave portion 2h and a light conductive lens supporting portion 2i.

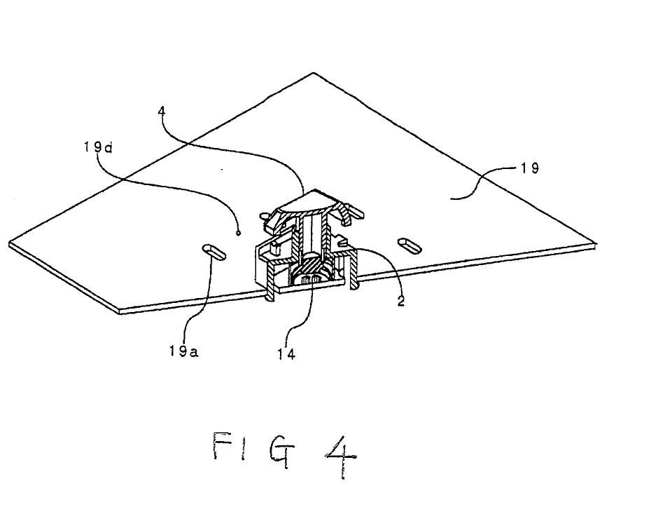

As shown in FIG. 3, the lug 2a is inserted into an through hole 19a processed in a print wing board 19 and provided for fixing the key switch 1 securely to the print wiring board 19.

As shown in FIGS. 1 and 3, the shaft supporting portion 2c provides the sliding surface 2b for supporting a shaft portion 4c of the button base 4, in which the sliding surface 2b is formed of a slidable ABS or a nylon resin and extended, for example, not shorter than 8 millimeters in a sliding direction of the button base 4 in order to reserve stable slide along the shaft portion sliding surface 4d.

As shown in FIG. 3, the lug taper 2d is provided for serving an insertion of the lug 2 into the through hole 19a when the switch base 2 is fixed on a part installing surface 19b of the print wiring board 19. And the protruding surface 2e is locked to a reverse side 19c of the print wiring board 19 after the switch base 2 is mounted on the print wiring board 19 and prevent the switch base 2 from removing from the print wiring board 19. Further, the guide pin 2f is provided for guiding the switch base 2 to the print wiring board 19 when the switch base 2 is fixed and inserted into the through hole 19a of the print wiring board 19, as shown in FIG. 5.

As shown in FIG. 8, the switch base convex portion 2g and switch base concave portion 2h provided on a side surface of the switch base 2 are provided for fitting and fixing the switch base convex portion 2g and switch base concave portion 2h adjacent to each other, in the event of a successive installation of the switch base 2.

As shown in FIG. 1, the light conductive lens supporting portion 2i provided on an upper surface of the switch base 2 fixes and supports the light conductive lens 16.

As shown in FIGS. 1 and 3, the button base 4 provides the shaft portion 4c supported by the shaft supporting portion 2c of the switch base 2, in which the slidable ABS or the nylon resin for enhancing the slidability are used in the shaft portion sliding surface 4d slidably connected to the sliding surface 2b. The shaft portion depressing surface 4e of the shaft portion 4c is accessible to the contact rubber 3 and depresses the contact rubber 3 down via the shaft portion depressing surface 4e when the button base 4 is depressed. Then, the conductive portion 13 contacts the electrical contact copper foil portion 14 and satisfies the electrical contact function as a key switch. Further, a notch 4a of the button base 4 is formed to lead the light emitted from a chip LED 15 to outside via the light conductive lens l6.

As shown in FIG. 5, the button base 4 is composed to have the label 31 affixed thereon and to be covered by the key cap 29.

As shown in FIGS. 1 and 3, the contact rubber 3 is located at lower part of the button base 4 in the switch base 2 and provides the contact rubber depressing surface 3a accessible to the shaft portion depressing surface 4e. The conductive portion 13 is welded at a lower portion of a main body of the contact rubber 3.

As shown in FIG. 1, the light conductive lens 16 is installed in the switch base 2 and supported by the light conductive lens supporting portion 2i. The light conductive lens 16 comprises a light receiving surface 16a and light emitting surface 16b and leads the light emitted form the chip LED 15 to the notch 4a of the button base 4.

As shown in FIGS. 1 and 3, the chip LED 15 is installed on the print wiring board 19 and the electrical contact copper foil portion 14 is formed on a surface opposing to the conductive portion 13 of the contact rubber 3. And as shown in FIG. 5, the through hole 19a and the fixing hole 19b to which the lug 2a of the switch base 2 and the guide pin 2f are inserted respectively are drilled.

Incidentally, it is preferable to use UL-recognized material with high flame resistance for the above-mentioned components.

Referring now to FIG. 5, a sequence of assembling the key switch having the above-mentioned composition.

At first, the electrical contact copper foil portion 14 is formed on the print wiring board 19 on which the chip LED 15 is installed. Then, the contact rubber 3 is placed at lower portion of the button base 4, after the light conductive lens 16 is installed in the switch base 2 and the shaft portion 4c is inserted into the shaft supporting portion 2c. The key cap 29 is placed over the button base 4 with the label 31 affixed thereon.

Thereafter, the lug 2a is inserted into the through hole 19a while the guide pin 2f of the switch base 2 is inserted into the fixing hole 19d of the print wiring board 19. Then, the lug taper portion 2d of the lug 2a descends sliding along the inner periphery of the through hole 19a. When the lug 2a is completely inserted, the protruding surface 2e is locked to the reverse surface 19c of the print wiring board 19 and installation of the key switch 1 on the print wing board 19 is completed.

Next, an operation of the key switch having the above-mentioned composition is described.

In FIGS. 1 and 3, when an operator depresses the button depressing surface 4b of the button base 4, the contact rubber depressing surface 3a of the contact rubber 3 is depressed by the shaft portion depressing surface 4e. Further the conductive portion 13 welded to the contact rubber 3 is depressed and contacts the electrical contact copper foil portion 14 formed in the print wiring board 19, thereby establishing the electrical contact function.

Thereafter, when the chip LED 15 illuminates after the conductive portion 13 contacts the electrical contact copper foil portion 14, the light emitted from the chip LED 15 is led from the light receiving surface 16a to the light emitting surface 16b of the light conductive lens 16 and further to outside via the notch 4a of the button base 4, which enables the operator and third parties to recognize the illumination.

Incidentally, as shown in FIG. 8, in the event that the switch bases 2 are installed successively on the print wiring board 19, the switch base convex portion 2g and the base concave portion 2h adjacent thereto can be fitted and fixed to each other.

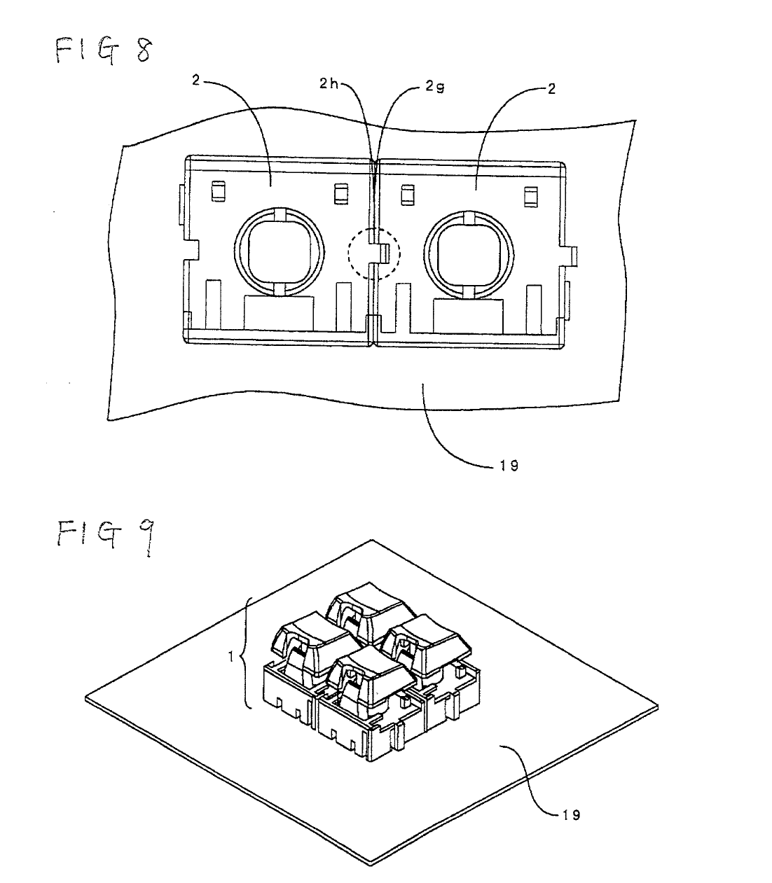

FIG. 9 illustrates the key switches 1 in the state of being installed successively on the print wiring portion 19. The LED illuminated key switch can be installed systematically, for example, with 19-millimeter pitch on the print wiring board 19.

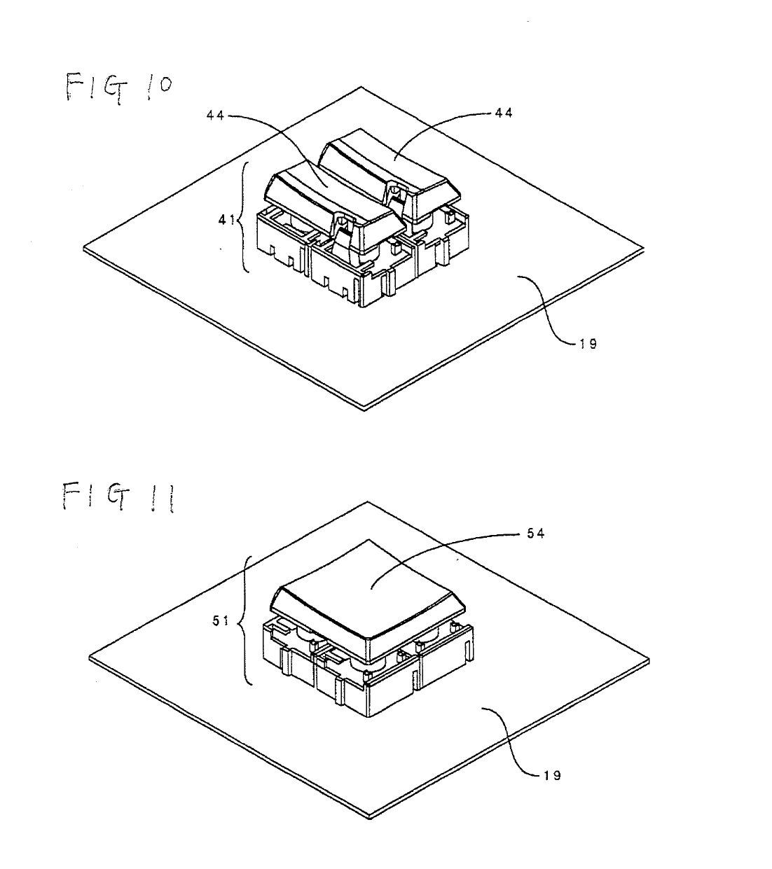

Referring now to FIG. 10, a second embodiment of the key switch relating to the present invention is described.

The key switch 41 relating to the present embodiment is indicated in the event of extending a side in the shape of the button base 4 to be twice in length and can be corresponded only by changing the button base 4 of the key switch 1 in the first embodiment to a button base 44. Thus, key switches having button bases in various shapes can be disposed functionally on an operation panel, which can achieve enhancement of operability and development to designing of operation panel surfaces effectively.

Referring now to FIG. 11, a third embodiment of the key switch relating to the present invention is described.

The key switch 51 relating to the present embodiment is indicated in the event of expanding the shape of the button base 4 to be four times in size and can be corresponded only by changing the button base 4 of the key switch 1 in the first embodiment to a button base 54. Thus, similar effects as the second embodiment can be obtained.

As clear from the description above, according to the present invention, a key switch with high productivity, high degree of flexibility in disposing on a print wiring board and excellent visual recognition from other directions than an upper part of the key top can be provided.

What is claimed is:

1. A key switch comprises;
a button base providing a button depressing surface and a shaft portion successively thereto,
a switch base mountable on a print wiring board providing a shaft supporting portion for supporting the shaft portion of said button base slidably,
a contact rubber mounted on said print wiring board accessibly to an end portion of a reverse side of said button depressing surface of said shaft portion of said button base, and
a light emitting portion provided on said print wiring board, wherein said shaft portion is lowered by depressing said button depressing surface of said button base, said conductive portion of said contact rubber is lowered by the descent of the shaft portion, electrical contact function is exerted by making contact with an electrical contact on said print wiring board, and said emitting portion emits light when said conductive portion makes contact with said electrical contact

2. A key switch as claimed in claim 1, wherein said switch base is detachable from said print wiring board.

3. A key switch as claimed in claim 2, wherein a lug portion is protruded from a lower portion of said switch base and said key switch is installable on said print wiring board by inserting and locking the lug portion in a through hole drilled in said print wiring portion.

4. A key switch as claimed in at least one of claims 1, 2 and 3, wherein a guide pin is protruded from a lower portion of said switch base and registration of said key switch with respect to said print wiring board is performed by inserting said guide pin into a fixing hole drilled in said print wiring board.

5. A key switch as claimed in at least one of claims 1 through 4, wherein said switch bases of said key switches adjacent to each other are engagable.

6. A key switch as claimed in claim 5, wherein said adjacent key switches are engagable to each other by fitting a convex portion protruded from said switch base of said key switch on one side into a concave portion formed in said switch base of said key switch on the other side.

7. A key switch as claimed in at least one of claims 1 through 6, wherein a sliding range of the shaft portion of said button base along the shaft supporting portion of said switch base is set not shorter than a fixed length.

8. A key switch as claimed in at least one of claims 1 through 7, wherein a lens for leading light emitted from the light emitting diode (LED) installed on said print wiring board as an emitting portion for emitting light when said conductive portion contacts said electrical contact to outside through notches formed on the button depressing surface of said button base.

9. A key switch as claimed in at least one of claims 1 through 8, wherein a label is removably affixed on the button depressing surface of said button base

10. A key switch as claimed in at least one of claims 1 through 8, wherein a key cap for insertably surrounding the button depressing surface of the button base on said button base.
